(19) United States
(12) Patent Application Publication
(10) Pub. No.: US 2009/0276080 A1
(43) Pub. Date: Nov. 5, 2009

(54) MACHINE TOOL MONITORING DEVICE

(76) Inventor: Reiner Krapf, Reutlingen (DE)

Correspondence Address: MERCHANT & GOULD PC, P.O. BOX 2903, MINNEAPOLIS, MN, 55402-0903, US

(21) Appl. No.: 12/306,401

(22) PCT Filed: Jul. 27, 2007
(86) PCT No.: PCT/EP07/57783

§ 371 Date: Dec. 23, 2008

(30) Foreign Application Priority Data
Sep. 4, 2006 (DE) 10 2006 041 756.9

(51) Int. Cl. G06F 19/00

(52) U.S. Cl. 700/177

(57) ABSTRACT

The invention proceeds from a machine tool monitoring device having a detection unit for detecting an application situation in a machine tool. It is proposed that the detection unit is provided to detect an application situation on the basis of at least one distance parameter.

### TECHNICAL FIELD

The invention is based on a machine tool monitoring device according to the generic term of claim 1.

A machine tool monitoring device for monitoring a machining process of a disc saw is known. Therefore the machine tool monitoring device provides a sensor unit for producing and detecting an electromagnetic signal, which is arranged close to the saw blade. The approach of a body part to the saw blade can be detected by monitoring the frequency spectrum of the signal.

### SUMMARY

The invention proceeds from a machine tool monitoring device with a detection unit for detecting an application situation in a machine tool.

It is suggested that the detection unit is provided to detect an application situation with the aid of at least one distance parameter. Thereby a reliable machine tool monitoring device that is based on established detection methods and evaluation procedures can be achieved. In this context a ‘distance parameter’ means in particular a parameter, with which a distance can be determined. The distance parameter is preferably detected by a detection signal as for example an electromagnetic signal, especially a light signal, or an ultrasound signal. The distance parameter can thereby be a duration, a phasing, a frequency of the detection signal or parameters that has been detected by a triangulation procedure and so on. These can for example after receiving the detection signal be converted in an electric distance parameter, as for example an electric voltage, electric current, load and so on. The distance parameter can furthermore be evaluated for detecting the application situation without a quantitative determination of the corresponding distance. A ‘detection’ of a application situation can be understood in this context in particular as the determination of the presence of a certain situation of an application process of the machine tool. The application process of the machine tool is thereby especially not limited to the use of the machine tool in accordance with the requirements. Even an improper use without a work piece that has to be worked on can be understood as an application situation of the machine tool. The determination of the presence of a certain situation can thereby advantageously serve for introducing safety measures.

The machine tool monitoring device according to the invention especially qualifies for machine tools, at which an application process is undertaken with the aid of a manual operation, as for example by handling a work piece during its machining. In particular a high safety can be achieved at such machine tool machining processes, which have the danger that an operator come into contact with a machining tool, as for example a cutting tool. Therefore the detection unit advantageously provides at least one monitoring area, in which preferably the distance parameter is detected, which is arranged in a mounting area of the machine tool for mounting a work piece to the tool. The mounting area preferably provides a guide means, which is provided for guiding the tool by the operator.

For evaluating the detected distance parameter, in particular for determining the application situation with the aid of the distance parameter, the detection unit provides preferably a arithmetic unit, which is arranged for example as a microprocessor and microcontroller.

It is furthermore suggested that the detection unit is provided to detect the application situation with the aid of a set of distance parameters, whereby a particularly precise and reliable detection of an application situation can be achieved. A high amount of possible application situations can be simply detected by comparing several distance parameters. A distance parameter can be very advantageous for confirming or invalidating a can-situation that has been determined with the aid of a further distance parameter. The distance parameters that serve for the detection can corresponds with different detection areas at a preset point of time and/or be distributed over a time interval.

The detection unit preferably provides a sensor tool, which is provided for detecting one or several distance parameters. The sensor tool can be arranged as a laser distance meter, triangulation sensor, ultrasound sensor, radar or ultra-wideband sensor

It is suggested in a preferred embodiment of the invention that the detection unit provides at least one set of sensor tools for detecting at least one distance parameter, whereby a monitoring of large spaces can be achieved.

In order to be able to achieve a precise and reliable detection of an application situation, it is especially proposed that the detection unit provides at least three sensor tools for detecting a distance parameter.

An extra simple evaluation method can be achieved if the detection unit is provided to detect the application situation by a difference between distance parameters. Thereby a difference between distance parameters at a point of time and/or between distance parameters at different points of time can serve for detecting the application situation.

It is suggested in an advantageous embodiment that the detection unit is provided to detect the application situation by a time change of a distance parameter. Thereby a fast detection of the application situation can be achieved. This can be achieved very easily if the detection unit is set to detect and/or receive changes with a high changing rate, as for example jumping transitions or discontinuities in the time course of the distance parameters. Furthermore the detection unit can be provided for detecting preset patterns in the time course of the distance parameter.

A high flexibility in configuration of monitoring functions can be achieved, if the detection unit determines at least two monitoring areas for monitoring an application process of the machine tool. A monitoring area is preferably assigned to a sensor tool or a set of sensor tools. A monitoring area can thereby for example correspond with a detection area of a sensor tool.

It is furthermore suggested that the monitoring areas are each assigned to a different operating mode of the machine tool, whereby a high flexibility in the application of the machine tool can be achieved. Therefore the detection unit is preferably connected with a control unit of the machine tool. The operating modes can for example correspond with different security steps at an operation of the machine tool.

In this context an advantageous warning effect and a high security can be achieved, if the detection unit is provided for slowing down a tool drive during warning mode together with a machine tool drive unit for driving a tool. Therefore the detection unit preferably provides an interface, which is provided for coupling with a control unit for controlling the machine tool drive unit. The detection unit can further provide a control unit for sending a control signal to the machine tool drive unit.

It is proposed in a preferred embodiment of the invention that at least one of the monitoring areas is assigned to a security cut-off of the machine tool, whereby a high operating security of the machine tool can be achieved.

It is furthermore suggested that the detection unit comprises an arithmetic unit, which is provided to detect the application situation by an evaluation of distance parameters that are based on a fuzzy and/re neuronal logic. With the aid of a fuzzy and/or neuronal logic a large and complex information amount can be quickly evaluated by the arithmetic unit. A ‘fuzzy logic’ means in this context especially a logic, which assigns the occurrence of a certain event to a probability value in the interval between 0 (false) and 1 (right).

A further embodiment suggests that the detection unit provides a data base, in which a set of distance parameters is assigned to an application situation, whereby a simple detection process of an application situation can be achieved. Advantageously the data base can be programmed by an end-user.

Furthermore a procedure for detecting an application situation at a application process of a machine tool is proposed, at which at least one distance parameter is detected for detecting the application situation. Thereby a secure detection procedure with established detection means can be easily achieved.

### BRIEF DESCRIPTION OF THE DRAWINGS

Further advantages arise from the following drawing description. The drawing shows embodiments of the invention. The drawing, the description and the claims contains numerous characteristics in combination. The expert will expediently consider these characteristics also individually and summarize them to further useful combinations.

It is shown in:

FIG. 1 is a disc saw with a saw bench, from which a saw blade sticks out, and a monitoring device with three distance sensors;

FIG. 2 is the disc saw from FIG. 1 with an alternative embodiment of the monitoring device;

FIG. 3 is the disc saw from FIG. 1 in a view from above with an alternative monitoring device, which provides four monitoring areas;

FIG. 4 is an internal circuit of the disc saw in the embodiment from FIG. 3;

FIGS. 5 and 6 are machining processes with the disc saw from FIG. 3;

FIGS. 7 and 8 are diagrams for explaining the detection function of the monitoring device;

FIG. 9 is a data base of the monitoring device;

FIG. 10 is a saw bench, a work piece and a hand that is put on the work piece; and

FIG. 11 is a course of a distance parameter in the situation from FIG. 10.

### DETAILED DESCRIPTION

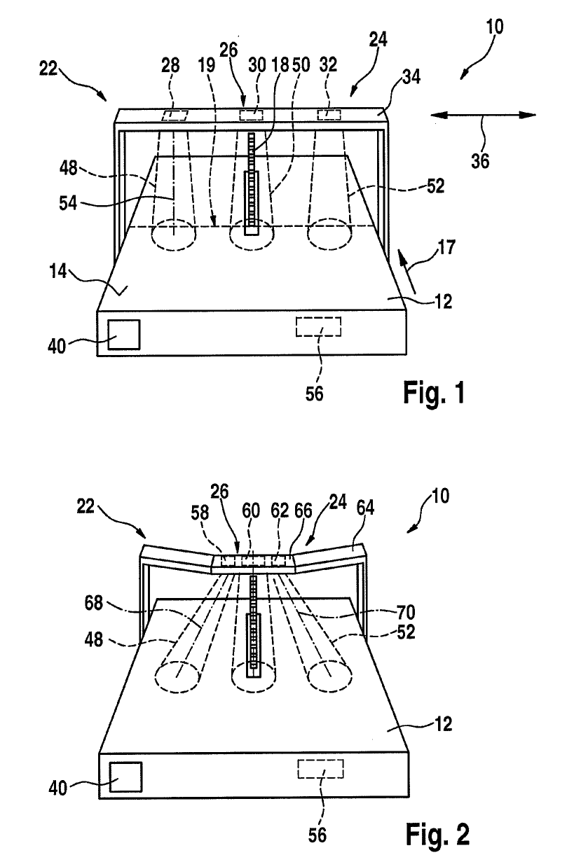

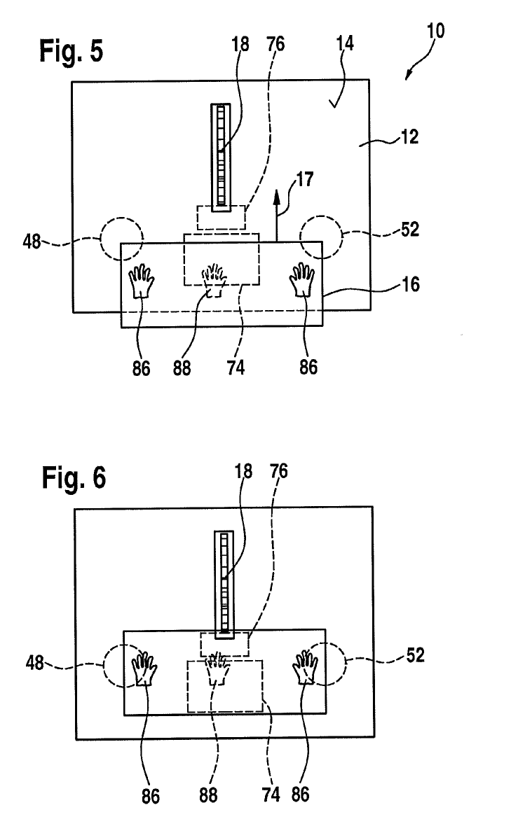

FIG. 1 shows a machine tool 10 that is arranged as a disc saw from a perspective view. It comprises a saw bench 12 with a machining area 14, on which a work piece 16 (FIG. 5) can be put on, a tool 18 that is arranged as a saw blade, which sticks out of the saw bench 12 and a machine tool drive unit 20 arranged as electromotor for driving the tool 18 (see FIG. 4). When machining the work piece 16 by an operator the work piece 16 is pushed in a mounting direction 17 against the tool 18. Therefore the part of the machining area 14, which is arranged in mounting direction 17 in front of the tool 18, creates a mounting area 19, on which the tool 16 is guided. The limitation of the mounting area 19 is shown in the figure by a dotted line.

For monitoring machining processes of the machine tool 10 it is provided with a machine tool monitoring device 22. The machine tool monitoring device 22 provides a detection unit 24, which is provided to detect an application situation that occurs during a machining process of the machining tool 10. Therefore the detection unit 24 comprises a sensor unit 26, which is arranged as a set of three sensor tools 28, 30, 32. The sensor unit 26 is fixed in a support element 34, which reaches over the width of the saw bench 12 above the machining area 14. Therefore the sensor tools 28, 30, 32 are arranged along a sensor axis 36, which oriented across the mounting direction 17 for mounting the work piece 16 to the tool 18. The machine tool 10 furthermore provides a signal output unit 40 that is arranged as a loudspeaker. An optical signal output unit is also possible.

The sensor tools 28, 30, 32 are each arranged as distance sensors. In this embodiment the sensor tools 28, 30, 32 are each arranged as infrared sensors, which detect a distance parameter 42, 44, 46 (see for example FIG. 4) with the aid of a triangulation procedure. This type of sensors as well as the detection of a distance parameter by a triangulation are familiar so that they are not further explained in this description. The sensor tools 28, 30, 32 each determine a monitoring area 48, 50, 52, whose projection is schematically illustrated on the machining area 14 by a dotted line, within which a detection of the distance parameter 42, 44 or 46 can take place. The monitoring areas 48, 50, 52 of the detection unit 24 are located in the mounting area 19 of the machining area 14. The distance parameters 42, 44, 46 correspond each with a distance to an object that is in the corresponding monitoring area 48, 50 or 52 or, at a free monitoring area, the distance to the machining area 14. The monitoring areas 48, 50, 52 reach cone-shaped along a detection direction 54, which is arranged vertically to the machining area 14 of the saw bench 12.

For detecting an application situation with the aid of the distance parameters 42, 44, 46 the detection unit 24 is supplied with an arithmetic unit 56, which is arranged as a microprocessor. It is arranged below the saw bench 12 and connected with the sensor unit 26 above cable joints. An alternative arrangement of the arithmetic unit 56, as for example in the support element 34, is also possible.

An alternative embodiment of the machine tool monitoring device 22 is shown in FIG. 2. The sensor unit 26 is thereby incorporated with three sensor tools 58, 60, 62 in an alternative support element 64. It is supported in the rear area of the saw bench 12 and provides a section 66 for receiving the sensor tools 58, 60, 62, which ranges over a part of the width of the saw bench 12. By arranging the sensor tools 58, 60, 62 in this section 66 the monitoring areas 48, 52 spread cone-shaped along detection directions 68, 70, which are arranged angularly to the machining area 14. In this embodiment the detection unit 24 is provided for an ultra-wide-band operation. The sensor tools 58, 60, 62 of the sensor unit 26 are therefore each arranged as UWB-sensors (ultra-wide-band sensors). They are provided for detecting a distance parameter by an electromagnetic signal that is realized as a wide-band signal, which provides a medium frequency between 1 GHz and 150 GHz and a frequency width of at least 500 Hz.

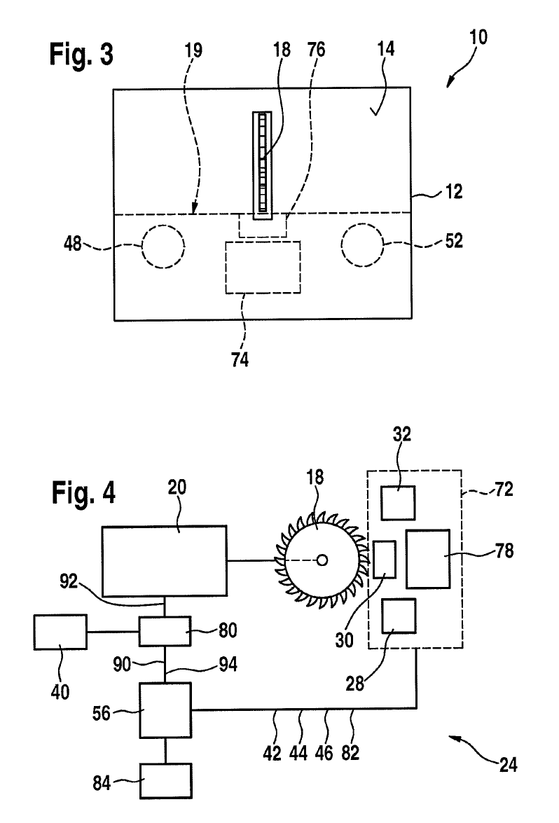

A further embodiment of the machine tool monitoring device 22 from FIG. 1 is described by FIG. 3, in which the machine tool 10 is shown in a view from above. The detection unit 24 is thereby provided with an alternative sensor unit 72. For clarity purposes the illustration of the support element 34 from FIG. 1 and the sensor unit 72 has been waived. The sensor unit 72 is shown in FIG. 4. Illustrated are the projections of the monitoring areas 48, 52 and of two further monitoring areas 74, 76 on the machining area 14. The monitoring areas 48, 52, 74, 76 are arranged in the mounting area 19 of the machining area 14. The monitoring areas 74, 76 are arranged in the mounting direction 17 in front of the tool 18, whereby the monitoring area 76 is arranged directly in front of the tool 18 and the monitoring area 74 is located in mounting direction 17 in front of the monitoring area 76. The monitoring areas 48, 52 are arranged sideways next to the monitoring areas 74, 76, whereby the term ‘sideways’ relates to the sensor axis 36 vertical to the mounting direction 17. The monitoring areas 48, 76, 52 are determined by the sensor tools 28, 30, 32 from FIG. 1, while the monitoring area 74 corresponds with a further sensor tool 78, which is shown in FIG. 4. The sensor tool 78 can be arranged as triangulation sensor, as UWB-sensor or as a further distance sensor that seems useful for the expert.

FIG. 4 schematically shows an internal circuit of the machine tool 10. The tool 18 realized as saw blade, a detection unit 24, the machine tool drive unit 20, a control unit 80 for controlling the machine tool drive unit 20 and the signal output unit 40 are illustrated. The detection unit 24 provides the sensor unit 72, which comprises the sensor tools 28, 30, 32, 78, and the arithmetic unit 56. The arithmetic unit 56 connected with the sensor unit 72 for receiving the distance parameters 42, 44, 46 and a distance parameter 82 that has been detected by the sensor tool 78. The arithmetic unit 56 is furthermore connected with the control unit 80. The distance parameters 42, 44, 46, 82 are arranged in this example as electrical voltages, which are emitted by the sensor tools 28, 30, 32, 78 of the sensor unit 72 depending on a distance in the corresponding monitoring area 48, 76, 52 or 74. Furthermore the arithmetic unit 56 is connected with a memory unit 84.

The arithmetic unit 56 is connected in this example with the control unit 80 by a cable joint. In an alternative embodiment it is possible that the arithmetic unit 56 is arranged in the support element 34 (see FIG. 1) and provided for creating a data connection with the control unit 80 over a wireless connection as for example over a radio communication. An optimal use of the machine tool monitoring device 22 in combination with the machine tool 10 with a small installation effort can be thereby achieved very easily.

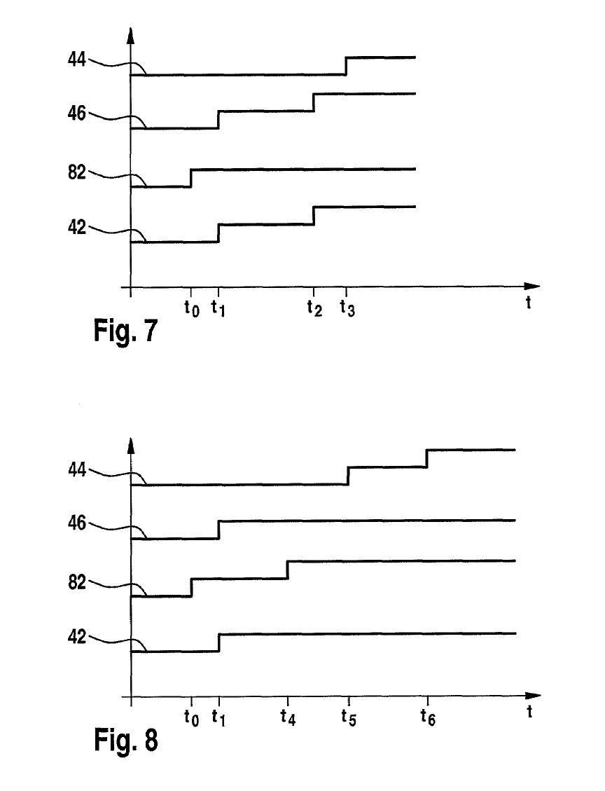

Machining processes with the machine tool 10 are explained by FIGS. 5 and 6. Furthermore it is referred to FIGS. 7 and 8 for explaining the functioning of the machine tool monitoring device 22. FIGS. 7 and 8 illustrate the distance parameters 42, 44, 46, 82 realized as electrical voltages that have been emitted by the sensor tools 28, 30, 32, 78 as a function of the time t in a diagram. For clarity purposes the corresponding distance parameters 42, 44, 46, 82 are each shown in a separate area of the ordinate. The distance parameters 42, 82, 46 or 44 are each assigned to the sensor tools 28, 78, 32 or 30.

It is assumed that an operator undertakes the machining of the work piece 16 that is realized as a wood plank by the machine tool 10. Before putting the work piece 16 onto the machining area 14 the detected distance parameters equal the same distance of the sensor tools 28, 78, 32, 30 to the machining area 14. The work piece 16 is put on the machining area 14 and moved by the operator in mounting direction 17 towards the tool 18. At the point of time to the work piece 16 gets into the monitoring area 74. As it can be seen in FIG. 7 the distance parameter 82 provides a jumping transition, which corresponds with the reduction of the distance by the thickness of the work piece 16 in the monitoring area 74. At the point of time t₁ the work piece 16 enters the monitoring areas 48 and 52, whereby the distance parameters 42, 46 provide a jumping transition. It is further assumed that the operator's hands are located at the edges of the work piece 16 (drawn through hand symbols 86) when moving the work piece 16 in mounting direction 17. When moving the work piece 16 further the operator's hands each get into a monitoring area 48, 52 at a point of time t₂ (FIG. 6). This is registered by the sensor tools 28, 32 (see FIG. 7). At a later point of time t₃ the work piece 16 gets into the monitoring area 76.

The arithmetic unit 56 is programmed to detect application situations by a logic method. An application situation is achieved as a result of a logic detection chain. The arithmetic unit 56 monitors thereby differences between the distance parameters 42, 82, 46 on the one hand and registers the time course of all distance parameters on the other hand. In particular the number of jumping transitions is registered for each distance parameter. The corresponding evaluation program is saved in the memory unit 84.

In between the point of time t₁ and t₂ all differences between the distance parameters 42, 82, 46 equal zero. The arithmetic unit 56 interprets this as a secure application situation, for which no further measures are necessary. If the hands get into the monitoring areas 48, 52 at the point of time t₂ a difference of the distance parameters 42, 46 to the distance parameter 82 is registered. This actuates a next step in the logic detection procedure, in which the statuses of the distance parameters as well as their time courses are used. The arithmetic unit 56 determines in particular that the distance parameter 44 is still in its starting status at the point of time t₂. This is again detected as an application situation, which requires no further measures.

It is registered at the point of time t₃ that the distance parameter 44 changes its value. With the aid of this information the arithmetic unit 56 analyses the statuses of the remaining distance parameters. Because the values of theses distance parameters remain unchanged, which corresponds with a further presence of hands in the monitoring areas 48, 52, this is detected by the arithmetic unit 56 as an uncritical application situation.

It is now assumed that the operator has put one hand in the center point of the work piece 16. This is described by the diagram in FIG. 8. This situation is shown in FIGS. 5 and 6 by a dotted hand symbol 88. The work piece 16 enters like in the previous example at the point of time t₃ into the monitoring area 74. At the point of time t₅ the hand gets into the monitoring area 74. A difference of the distance parameters 82 to the distance parameters 42, 46 occurs thereby, which is registered by the arithmetic unit 56. The arithmetic unit 56 furthermore detects that a second discontinuity of the distance parameter 82 occurred. This is recognized as an application situation in a logic chain of the arithmetic unit 56, in which a warning mode of the machine tool 10 has to be turned on. The arithmetic unit 56 supplies therefore a warning signal 90 to the control unit 80 (FIG. 4), which causes the output of an acoustic signal by the signal output unit 40 on the one hand and sends a control signal 92 to the machine tool drive unit 20 on the other hand. The engine speed of the tool 18 is thereby for example adjusted to a lower value.

If the operator ignores these warnings and his hand gets into the monitoring area 76 at a point of time t₆, the corresponding second jumping transition of the distance parameter 44 is registered by the arithmetic unit 56, which detects this application situation as an acute danger situation. The arithmetic unit 56 supplies hereby a stop signal 94 to the control unit 80, which causes a security cut-off of the machine tool drive unit 20.

Due to the detection unit 24, which actuates the warning signal 90 and the stop signal 94 by reducing the distance in the monitoring area 74 or 76, a false negative detection, in which the danger of an application situation is underestimated, can be excluded. Due to the further monitoring areas 48, 52, in particular by a comparison between distance parameters, false positive detection, in which a warning or a security cut-off is causes by overestimating the danger of an application situation, can be advantageously prevented. To prevent the output of such false positive signals and to increase the application comfort the above described sensor technology by distance sensors can be advantageously combined with a further sensor technology, in particular for the material detection. The additional use of a capacitive detection and/or a detection, which is based on the use of an infrared-signal for detecting body heat, on a spectroscopic procedure for detecting human tissue and/or on an optical procedure, for example by a video camera, is also possible. This can be achieved by the use of further sensor tools. It can be constructively achieved simply by providing at least the sensor tool 30 in addition to the distance detection for the material detection. The sensor tool 30 can for example be arranged as an UWB-sensor.

The functioning of the machine tool monitoring device 22 in the embodiment from FIG. 1 can be taken from the previous description, with the difference that the monitoring area 74 is waived. This monitoring area 74, which can be seen as a warning area, has the additional advantage that it can be reacted upon a critical application situation before a physical contact between the operator and the tool 18 occurs.

For explanation purposes of the functioning of the machine tool monitoring device 22 simple examples of application situations have been considered, due to which an application situation can be fast and securely detected by an arithmetic unit 56 that is programmed with a sharp logic. By detecting a set of distance parameters a variety of possible configurations of the distance parameters arises. For an effective detection of the application situation the arithmetic unit 56 is furthermore provided to detect the application situation by a fuzzy logic and a neuronal logic. Further advantageous self-learning functions of the machine tool monitoring device 22 can be achieved by a neuronal logic.

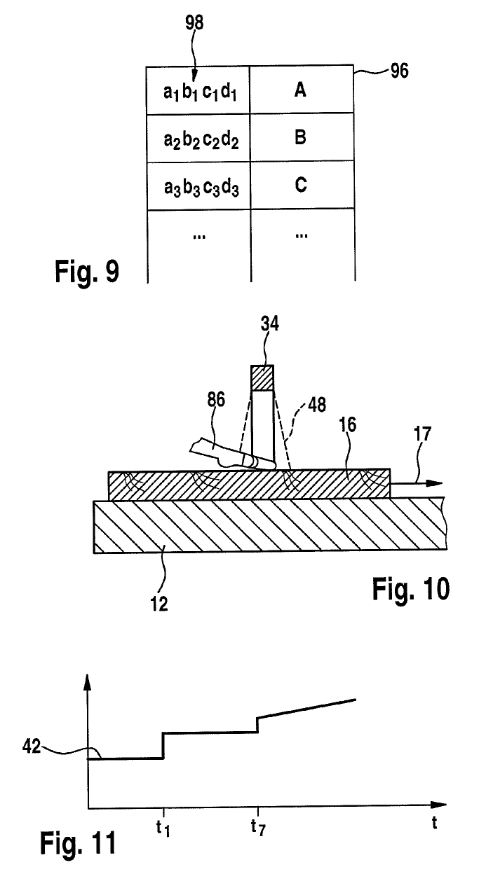

The arithmetic unit 56 can furthermore detect an application situation by a data base 96 that is saved in the memory unit 84. This data base 96 is shown in FIG. 9. Sets of distance parameters 98, which are shown by symbols a1, a2, . . . , b1, b2 . . . , c1, c2 and so on, are each assigned to an application situation A, B, C. By comparing a detected set of distance parameters with the saved sets a corresponding application situation can be detected. This data base 96 can be created for example by computer simulations, in which possible application situations are simulated, and subsequently save in series in the memory unit 84.

It is possible in a further embodiment that the detection unit 24 is provided for a pattern detection. Therefore the arithmetic unit 56 registers absolute values of distance parameters or distances that have been determined by these distance parameters. The arithmetic unit 56 can thereby for example be programmed to detect a typical hand thickness (for example in range of 2 and 5 cm).

A further detection mode of the arithmetic unit 56 is described in FIGS. 10 and 11. A hand can be distinguished from a work piece 16 thereby that the arithmetic unit 56 registers a continuous change in the course of a distance parameter, as for example the distance parameter 42. This variation, which can be noticed in FIG. 11 after the point of time t7 of the entering of the hand into the monitoring area 48, corresponds with an angular position of the hand on the work piece 16 and a reduction of the detected distance that results thereof and can be detected by the arithmetic unit 56 as a pattern course of the distance parameter 42.

The machine tool monitoring device 22 that is here described by a disc saw can be furthermore applied for the use at further machine tools, in particular at further types of saws, as for example chop- and/or miter saws, lawnmower and so on.

1-14. (canceled)

15. A machine tool monitoring device, comprising:
a detection unit for detecting an application situation in a machine tool, wherein the detection unit is configured to detect an application situation on the basis of at least one distance parameter.

16. The machine tool monitoring device of claim 15, wherein the detection unit is further configured to detect the application situation on the basis of a set of distance parameters.

17. The machine tool monitoring device of claim 15, wherein the detection unit comprises a plurality of sensor tools for detecting at least one distance parameter.

18. The machine tool monitoring device of claim 15, wherein the detection unit is further configured to detect the application situation on the basis of a difference between a plurality distance parameters.

19. The machine tool monitoring device of claim 15, wherein the detection unit is further configured to detect an application situation on the basis of a time change of at least one distance parameter.

20. The machine tool monitoring device of claim 15, wherein the detection unit determines at least two monitoring areas for monitoring an application situation of the machine tool.

21. The machine tool monitoring device of claim 20, wherein the at least two monitoring areas are each assigned to a different operating mode of the machine tool.

22. The machine tool monitoring device of claim 20, wherein at least one of the at least two monitoring areas is assigned to a warning mode of the machine tool.

23. The machine tool monitoring device of claim 22, wherein the detection unit, together with a machine tool drive unit for driving a tool, is further configured to slow down a tool drive in warning mode.

24. The machine tool monitoring device of claim 20, wherein at least one of the at least two monitoring areas is assigned to a security disconnection of the machine tool.

25. The machine tool monitoring device of claim 15, wherein the detection unit comprises an arithmetic unit configured for detecting the application situation by an analysis of at least one distance parameter based on at least one of: fuzzy logic; and neuronal logic.

26. The machine tool monitoring device of claim 16, wherein the detection unit comprises a data base, wherein the set of distance parameters is assigned to an application situation.

27. The machine tool monitoring device of claim 15, wherein the machine tool monitoring device is coupled to a machine tool.

28. A method of detecting an application situation of a machine tool under operation, the method comprising determining at least one distance parameter for detecting the application situation.
